(19) United States
(12) Patent Application Publication
(10) Pub. No.: US 2025/0102754 A1
(43) Pub. Date: Mar. 27, 2025

(54) OPTICAL FIBER CABLE

(71) Applicant: SUMITOMO ELECTRIC INDUSTRIES, LTD., Osaka-shi, Osaka (JP)

(72) Inventors: Fumiaki SATO, Osaka (JP); Masakazu TAKAMI, Osaka (JP); Toyoaki KIMURA, Osaka (JP)

(21) Appl. No.: 18/729,227

(22) PCT Filed: Jan. 17, 2022
(86) PCT No.: PCT/JP2022/001402

§ 371 Date: Jul. 16, 2024

(51) Int. Cl. G02B 6/44

(52) U.S. Cl. CPC G02B 6/4432; G02B 6/4436

(57) ABSTRACT

An optical fiber cable includes a plurality of optical fibers, a cable sheath covering the plurality of optical fibers, and a plurality of tension members embedded in the cable sheath. The plurality of tension members are arranged almost without gaps along a circumferential direction of the optical fiber cable to surround the plurality of optical fibers.

### TECHNICAL FIELD

The present disclosure relates to an optical fiber cable.

### BACKGROUND ART

As disclosed in Patent Literature 1, an optical fiber cable that is installed by being pneumatically fed in a duct such as a micro duct is known. In the optical fiber cable for pneumatic feeding disclosed in Patent Literature 1, in order to improve extensibility of the optical fiber cable, a plurality of tension members made of a tensile strength material such as fiber-reinforced plastic (FRP) are embedded in a cable sheath.

### CITATION LIST

### PATENT LITERATURE

Patent Literature 1: JP2020-197655A

### SUMMARY OF INVENTION

An optical fiber cable according to an aspect of the present disclosure includes a plurality of optical fibers, a cable sheath covering the plurality of optical fibers, and a plurality of tension members embedded in the cable sheath. The plurality of tension members are arranged without gaps along a circumferential direction of the optical fiber cable to surround the plurality of optical fibers.

### BRIEF DESCRIPTION OF DRAWINGS

FIG. 1 is a cross-sectional view showing an example of an optical fiber cable according to an embodiment of the present disclosure.

FIG. 2 is a view schematically showing a side of the optical fiber cable according to the embodiment of the present disclosure.

FIG. 3 is a cross-sectional view showing an example of an optical fiber cable according to a modification.

### DESCRIPTION OF EMBODIMENTS

### Technical Problem

In the optical fiber cable of Patent Literature 1, four tension members are arranged at equal intervals of 90 degrees along a circumferential direction of the optical fiber cable. For this reason, a gap between adjacent tension members in the circumferential direction widens, and imbalance occurs in bending stiffness in a radial direction of the optical fiber cable over an entire circumference of the optical fiber cable. As a result, the optical fiber cable is likely to bend in a specific radial direction, so there is a risk that the optical fiber cable may be buckled in the middle of a duct when being pneumatically fed or press-fitted. From the above standpoint, there is room for consideration of a structure of an optical fiber cable that allows for suitable pneumatic feeding of the optical fiber cable into a duct cable.

First, embodiments of the present disclosure are listed and described.
(1) An optical fiber cable including: a plurality of optical fibers; a cable sheath covering the plurality of optical fibers; and a plurality of tension members embedded in the cable sheath, in which the plurality of tension members are arranged without gaps along a circumferential direction of the optical fiber cable to surround the plurality of optical fibers.

According to the above configuration, the plurality of tension members are arranged without gaps along the circumferential direction of the optical fiber cable to surround the plurality of optical fibers. For this reason, the occurrence of imbalance in bending stiffness in a radial direction of the optical fiber cable over the entire circumference of the optical fiber cable is appropriately suppressed. As a result, a situation in which the optical fiber cable bends in a specific radial direction is appropriately prevented, so the optical fiber cable can be appropriately pneumatically fed into a duct such as a micro duct. Note that “the plurality of tension members are arranged without gaps” does not necessarily mean that there is no gap completely between adjacent tension members of the plurality of tension members. In this regard, a gap of about 0.5 mm may be present between adjacent tension members.
(2) The optical fiber cable according to the above (1), in which the plurality of tension members are made of fiber-reinforced plastic.

According to the above configuration, the optical fiber cable is made lighter compared to a case where the tension members are made of a metal material, so the optical fiber cable can be appropriately pneumatically fed into the duct cable.
(3) The optical fiber cable according to the above (1) or (2), in which the plurality of tension members are stranded along a longitudinal direction of the optical fiber cable.

According to the above configuration, since the plurality of tension members are stranded along the longitudinal direction, the imbalance in the bending stiffness in the radial direction of the optical fiber cable is reduced. In this way, buckling and fracture of the optical fiber cable can be appropriately suppressed.
(4) The optical fiber cable according to any one of the above (1) to (3), in which the plurality of tension members include: a plurality of inner tension members arranged along the circumferential direction to surround the plurality of optical fibers; and a plurality of outer tension members arranged along the circumferential direction to surround the plurality of inner tension members.

According to the above configuration, since the plurality of inner tension members and the plurality of outer tension members are embedded in the cable sheath, it is possible to further increase the bending stiffness in the radial direction of the optical fiber cable, and to further suppress the occurrence of imbalance in bending stiffness in the radial direction of the optical fiber cable over the entire circumference of the optical fiber cable.
(5) The optical fiber cable according to the above (4), in which the plurality of inner tension members are stranded in a first rotation direction along a longitudinal direction of the optical fiber cable, and the plurality of outer tension members are stranded in a second rotation direction opposite to the first rotation direction along the longitudinal direction.

According to the above configuration, since the inner tension members and the outer tension members are stranded in different rotation directions, the imbalance in bending stiffness in the radial direction of the optical fiber cable is further reduced. In this way, buckling and fracture of the optical fiber cable can be more appropriately suppressed.
(6) The optical fiber cable according to any one of the above (1) to (5), in which the cable sheath includes: an inner cable sheath; and an outer cable sheath covering the inner cable sheath, in which the plurality of tension members are arranged between the inner cable sheath and the outer cable sheath, and in which the outer cable sheath is made of flame-retardant polyethylene to which a release agent has been added.

According to the above configuration, since the outer cable sheath is made of flame-retardant polyethylene to which a release agent has been added, the flame retardancy of the optical fiber cable can be secured and friction occurring between the optical fiber cable and an inner surface of the duct can be reduced. In this way, the optical fiber cable can be appropriately pneumatically fed into the duct while securing the flame retardancy of the optical fiber cable. Note that the “release agent” referred to here is added to flame-retardant polyethylene not for the purpose of improving extrusion processability but for the purpose of reducing friction on the surface of the cable sheath. As the release agent, for example, a silicone-based material is used.
(7) The optical fiber cable according to the above (6), in which the inner cable sheath is made of flame-retardant polyethylene to which no release agent is added.

According to the above configuration, the inner cable sheath is made of flame-retardant polyethylene to which no flammable release agent used to reduce friction on a surface is added. For this reason, the flame retardancy of the inner cable sheath can be further improved compared to the outer cable sheath. In this way, the overall flame retardancy of the optical fiber cable can be sufficiently secured.
(8) The optical fiber cable according to any one of the above (1) to (7), in which a bending stiffness in a radial direction of the optical fiber cable over an entire circumference of the optical fiber cable is within a range of 1.0 N·m² to 9.0 N·m².

According to the above configuration, the bending stiffness in the radial direction of the optical fiber cable over the entire circumference of the optical fiber cable is within the range of 1.0 N·m² to 9.0 N·m², so both extensibility and flexibility of the optical fiber cable can be sufficiently secured, and the optical fiber cable can be appropriately pneumatically fed into the duct.
(9) The optical fiber cable according to any one of the above (1) to (8), in which a difference between maximum and minimum values of a bending stiffness in a radial direction of the optical fiber cable over an entire circumference of the optical fiber cable is within a range of 0.5 N·m² to 1.0 N·m².

According to the above configuration, the imbalance in bending stiffness in the radial direction of the optical fiber cable is suppressed over the entire circumference of the optical fiber cable, so a situation in which the optical fiber cable is bent in a specific radial direction is appropriately prevented. In this way, the optical fiber cable can be appropriately pneumatically fed into a duct such as a micro duct.

### Advantageous Effects of Present Disclosure

According to the present disclosure, it is possible to provide an optical fiber cable that can appropriately suppress the occurrence of imbalance in bending stiffness in the radial direction of the optical fiber cable over the entire circumference of the optical fiber cable.

### Description of Embodiments of Present Disclosure

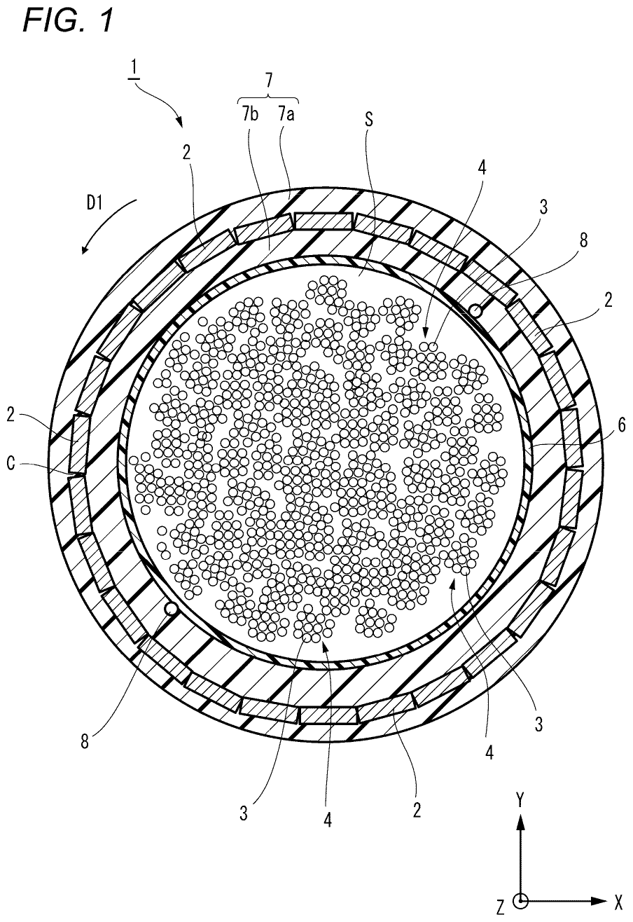

Hereinafter, an optical fiber cable 1 according to an embodiment of the present disclosure (hereinafter, referred to as the present embodiment) will be described with reference to FIG. 1. For convenience of description, the dimension of each member shown in the drawings may be different from the dimension of each actual member. In addition, in the present embodiment, an X-axis direction, a Y-axis direction, and a Z-axis direction set for the optical fiber cable 1 shown in FIG. 1 are appropriately mentioned. Each of the X-axis direction, the Y-axis direction, and the Z-axis direction is perpendicular to the other two directions. For example, the X-axis direction is perpendicular to the Y-axis direction and the Z-axis direction. The Z-axis direction corresponds to a longitudinal direction (axial direction) of the optical fiber cable 1.

FIG. 1 is a cross-sectional view showing the optical fiber cable 1 according to the present embodiment. The cross section of the optical fiber cable 1 shown in FIG. 1 is a cross section of the optical fiber cable 1 perpendicular to the Z-axis direction. As shown in FIG. 1, the optical fiber cable 1 includes a plurality of optical fiber ribbons 4, a plurality of tension members 2, a water-absorbing tape 6, and a cable sheath 7.

The optical fiber cable 1 is, for example, an optical fiber cable for pneumatic feeding that is pneumatically fed into a duct such as a micro duct. The plurality of optical fiber 15 ribbons 4 are housed in an accommodation space S of the optical fiber cable 1. Each of the optical fiber ribbons 4 includes a plurality of optical fibers 3 arranged in parallel. Each of the optical fiber ribbons 4 may be, for example, an intermittently bonded optical fiber ribbon in which at least some of adjacent optical fibers among the plurality of optical fibers 3 arranged in parallel are intermittently bonded along the Z-axis direction. Note that for the intermittently bonded optical fiber ribbon, the optical fibers may be intermittently connected therebetween along the longitudinal direction, and the manufacturing method is not limited.

The plurality of optical fiber ribbons 4 extend along the Z-axis direction. In particular, the plurality of optical fiber ribbons 4 may be spirally stranded along the Z-axis direction. As the type of stranding, an S stranding, a Z stranding, or an SZ stranding in which S and Z strandings are alternately performed may be adopted.

The optical fiber 3 includes a glass fiber and a resin coating that covers the glass fiber. The glass fiber includes at least one core through which signal light propagates and a clad that covers the core. A refractive index of the core is greater than that of the clad. In the present example, the plurality of optical fiber ribbons 4 are housed in the optical fiber cable 1, but instead of the optical fiber ribbons 4, a plurality of single core optical fibers 3 separated from each other may be housed in the optical fiber cable 1.

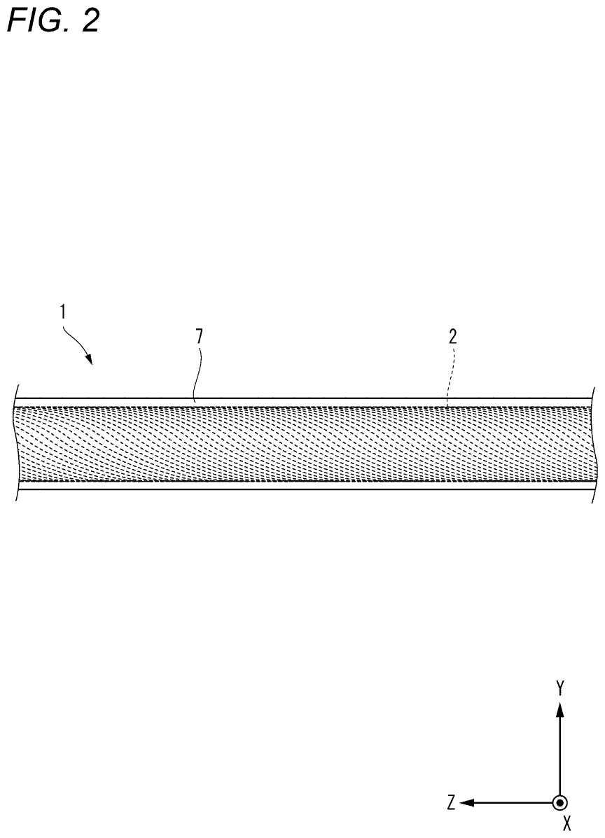

The plurality of tension members 2 are embedded in the cable sheath 7. As shown in FIG. 2, the plurality of tension members 2 extend along the Z-axis direction. In particular, the plurality of tension members 2 may be spirally stranded along the Z-axis direction. In this case, since the plurality of tension members 2 are stranded, imbalance in bending stiffness in a radial direction of the optical fiber cable 1 is reduced. In this way, buckling and fracture of the optical fiber cable 1 can be appropriately suppressed.

In the cross section of the optical fiber cable 1 shown in FIG. 1, the plurality of tension members 2 are arranged almost without gaps along a circumferential direction D1 of the optical fiber cable 1 to surround a bundle of the plurality of optical fiber ribbons 4 (or a bundle of the plurality of optical fibers 3). Here, the plurality of tension members 2 may be arranged without any gap along the circumferential direction D1. In this case, adjacent tension members may be in contact with each other. In addition, the plurality of tension members 2 may be arranged with some gaps along the circumferential direction D1. In this case, an interval of a gap C between adjacent tension members 2 may be within a range of 0.1 mm to 1.0 mm.

The tension member 2 is formed of a tensile strength material that is resistant to tension or compression. Specifically, the tension member 2 may be formed of fiber-reinforced plastic (FRP) such as aramid FRP, glass FRP, or carbon FRP. When the tension member 2 is made of FRP, the optical fiber cable 1 is made lighter compared to a case where the tension member 2 is made of a metal material, so the optical fiber cable 1 can be appropriately pneumatically fed into the duct.

In the present example, a cross section of each tension member 2 is substantially rectangular. In a case where the cross section of the tension member 2 is rectangular, opposing side surfaces of adjacent tension members 2 come into contact with each other, making it possible to arrange the tension members 2 without gaps. In addition, for example, when an inner diameter of the optical fiber cable 1 is 10.1 mm and an outer diameter of the optical fiber cable 1 is 13.5 mm, a width dimension of the tension member 2 may be 1.5 mm, and a thickness dimension of the tension member 2 may be 0.5 mm. Note that the cross section of the tension member 2 is not particularly limited, and may be, for example, approximately elliptical.

A length of the tension member 2 in the Z-axis direction may be shorter than a length of the optical fiber 3 in the Z-axis direction. In this case, since each optical fiber 3 has an extra length, when the optical fiber cable 1 is pulled, load is applied to the tension member 2 before excessive tension is generated in each optical fiber 3. For this reason, disconnection of each optical fiber 3 can be appropriately prevented.

The water-absorbing tape 6 is wound, for example, longitudinally or horizontally around a bundle of the plurality of optical fiber ribbons 4 (or a bundle of the plurality of optical fibers 3). The water-absorbing tape 6 is a tape that has undergone water-absorbing processing by attaching water-absorbing powder to a base fabric made of, for example, polyester. In addition, although not shown in FIG. 1, a coarse winding thread may be wound around a bundle of the plurality of optical fiber ribbons 4.

The tear string 8 is provided for tearing the cable sheath 7 and is embedded in the cable sheath 7. In the present example, two tear strings 8 are provided in the fiber optic cable 1. By pulling out the tear string 8, the cable sheath 7 can be torn along the Z-axis direction, and as a result, the optical fiber 3 can be taken out. The tear string 8 is made of, for example, a plastic material (for example, polyester) that is resistant to tension.

The cable sheath 7 is provided to cover the bundle of the plurality of optical fiber ribbons 4 (or the bundle of the plurality of optical fibers 3). The cable sheath 7 is formed of a flame-retardant resin such as flame-retardant polyethylene, for example. In the present embodiment, the cable sheath 7 is configured by an inner cable sheath 7b and an outer cable sheath 7a that covers the inner cable sheath 7b. In the radial direction of the optical fiber cable 1 (hereinafter, simply referred to as the radial direction), each tension member 2 is arranged between the inner cable sheath 7b and the outer cable sheath 7a.

The inner cable sheath 7b is located between the water-absorbing tape 6 and the plurality of tension members 2 in the radial direction, and is formed of, for example, flame-retardant polyethylene to which no silicone-based release agent is added. The outer cable sheath 7a is provided to cover the plurality of tension members 2 and is formed of flame-retardant polyethylene (in particular, flame-retardant high-density polyethylene) to which a silicone-based release agent has been added. The silicone-based release agent may be included in a ratio of 2 wt % or more, preferably 3 wt % or more and 5 wt % or less, with respect to the flame-retardant polyethylene.

In the present embodiment, since the outer cable sheath 7a is made of flame-retardant polyethylene to which the release agent has been added, the flame retardancy of the optical fiber cable 1 can be secured and friction occurring between the optical fiber cable 1 and the inner surface of the duct can be suppressed. In this way, the optical fiber cable 1 can be appropriately pneumatically fed into the duct while securing the flame retardancy of the optical fiber cable 1.

On the other hand, since the inner cable sheath 7b is made of flame-retardant polyethylene to which no flammable release agent is added, the flame retardancy of the inner cable sheath 7b can be further improved compared to the outer cable sheath 7a. In this way, the overall flame retardancy of the optical fiber cable 1 can be sufficiently secured.

In addition, in a manufacturing process of the optical fiber cable 1, a cable core composed of a bundle of the plurality of optical fiber ribbons 4 and the water-absorbing tape 6 is first prepared. Next, in a state in which the cable core is inserted into a first extruder, the inner cable sheath 7b covering the cable core is formed by extrusion molding using the first extruder. Then, the plurality of tension members 2 are wound on the cable core by a winding device to cover an outer periphery of the inner cable sheath 7b. Finally, in a state in which the cable core is inserted into a second extruder, the outer cable sheath 7a is formed by extrusion molding using the second extruder to cover the plurality of tension members 2. In this way, the optical fiber cable 1 shown in FIG. 1 is manufactured through the above manufacturing process.

According to the present embodiment, the plurality of tension members 2 are arranged almost without gaps along the circumferential direction D1 to surround the bundle of the plurality of optical fibers 3. For this reason, the occurrence of imbalance in bending stiffness in the radial direction of the optical fiber cable 1 over the entire circumference of the optical fiber cable 1 is appropriately suppressed. As a result, a situation in which the optical fiber cable 1 bends in a specific radial direction is appropriately prevented, so the optical fiber cable 1 can be appropriately pneumatically fed into a duct such as a micro duct.

In addition, in the present embodiment, the bending stiffness in the radial direction over the entire circumference of the optical fiber cable 1 is within the range of 1.0 N·m² to 9.0 N·m², so both extensibility and flexibility of the optical fiber cable 1 can be sufficiently secured, and the optical fiber cable 1 can be appropriately pneumatically fed into the duct. Note that bending stiffness is measured in conformity with IEC60794 Stiffness (MethodE17A).

In addition, a difference between the maximum and minimum values of the bending stiffness in the radial direction over the entire circumference of the optical fiber cable 1 is within a range of 0.5 N·m² to 1.0 N·m², so imbalance in bending stiffness in the radial direction is suppressed. For this reason, the situation in which the optical fiber cable 1 is bent in a specific radial direction (particularly, a radial direction in which the bending stiffness decreases) is appropriately prevented, and the optical fiber cable 1 can be appropriately pneumatically fed into the duct.

### Modifications

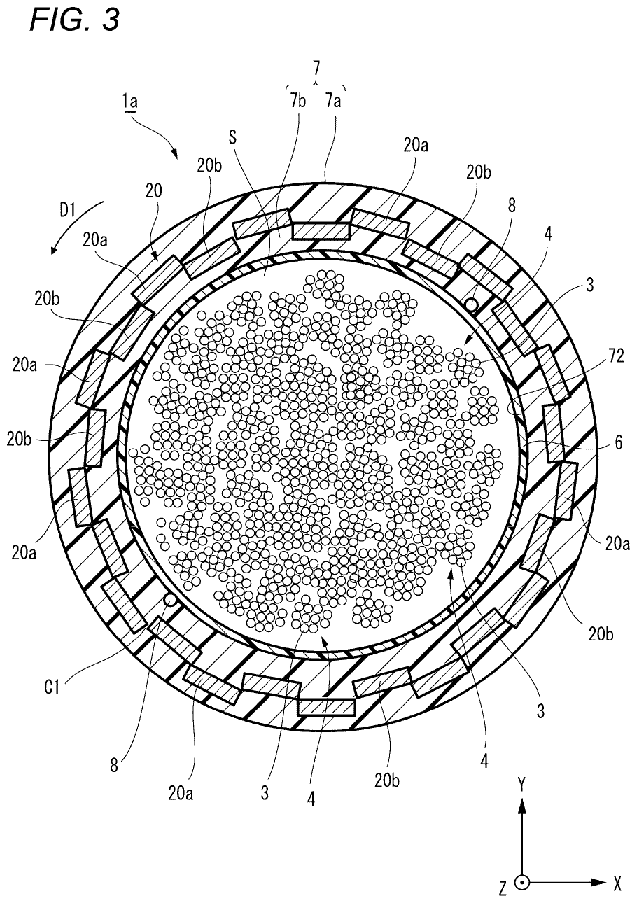

Next, an optical fiber cable 1a according to a modification of the present embodiment will be described below with reference to FIG. 3. FIG. 3 is a cross-sectional view showing an example of an optical fiber cable 1a according to a modification. The cross section of the optical fiber cable 1a shown in FIG. 3 is a cross section of the optical fiber cable 1a perpendicular to the Z-axis direction. In the following description, description of members having the same reference numerals as members already described in the above embodiment will be appropriately omitted.

As shown in FIG. 3, the optical fiber cable 1a is different from the optical fiber cable 1 in that a tension member has a two-layer structure. In this regard, a tension member 20 has a plurality of inner tension members 20b and a plurality of outer tension members 20a. The plurality of inner tension members 20b are arranged along the circumferential direction D1 to surround a bundle of the plurality of optical fibers 3. The plurality of outer tension members 20a are arranged along the circumferential direction D1 to surround the plurality of inner tension members 20b.

The inner tension members 20b and the outer tension members 20a are embedded in the cable sheath 7. The inner tension members 20b and the outer tension members 20a extend along the Z-axis direction. In particular, the inner tension members 20b and the outer tension members 20a may be spirally stranded along the Z-axis direction. In this regard, the inner tension members 20b are stranded in one rotation direction (an example of the first rotation direction) of a clockwise rotation direction or a counterclockwise rotation direction, while the outer tension members 20a are stranded in the other rotation direction (an example of the second rotation direction) of a clockwise rotation direction or a counterclockwise rotation direction. That is, the rotation direction of the stranding of the inner tension members 20b is opposite to the rotation direction of the stranding of the outer tension members 20a. In this way, since the inner tension members 20b and the outer tension members 20a are stranded in different rotation directions, the imbalance in bending stiffness in the radial direction of the optical fiber cable 1a is reduced. For this reason, buckling and fracture of the optical fiber cable 1a can be more appropriately suppressed.

A distance between each inner tension member 20b and an inner surface 72 of the cable sheath 7 in the radial direction of the optical fiber cable 1a (hereinafter, simply referred to as the radial direction) is shorter than a distance between each outer tension member 20a and the inner surface 72. That is, the inner tension members 20b are located on the radially inner side with respect to the outer tension members 20a. Along the circumferential direction D1, the inner tension members 20b and the outer tension members 20a are alternately arranged. That is, each inner tension member 20b is adjacent to two outer tension members 20a in the circumferential direction D1, while each outer tension member 20a is adjacent to two inner tension members 20b in the circumferential direction D1.

The plurality of inner tension members 20b and outer tension members 20a are arranged almost without gaps along the circumferential direction D1. Here, the plurality of inner tension members 20b and the plurality of outer tension members 20a may be arranged without any gap along the circumferential direction D1. In this case, the inner tension member 20b and the outer tension member 20a, which are adjacent to each other, may be in contact with each other. In addition, the inner tension member 20b and the outer tension member 20a, which are adjacent to each other in the circumferential direction D1, may partially overlap in the radial direction. Additionally, the plurality of inner tension members 20b and the plurality of outer tension members 20a may be arranged with some gaps along the circumferential direction D1. In this case, an interval of a gap C1 may be within a range of 0.1 mm to 1.0 mm.

A cross-sectional shape of the inner tension member 20b may be the same as or different from a cross-sectional shape of the outer tension member 20a. Similarly, a dimension of the cross-sectional shape of the inner tension member 20b may be the same as or different from a dimension of the cross-sectional shape of the outer tension member 20a.

According to the present modification, since the plurality of inner tension members 20b and the plurality of outer tension members 20a are arranged almost without gaps along the circumferential direction D1, the occurrence of imbalance in bending stiffness in the radial direction over the entire circumference of the optical fiber cable 1a is appropriately suppressed. As a result, a situation in which the optical fiber cable 1a bends in a specific radial direction is appropriately prevented, so the optical fiber cable 1 can be appropriately pneumatically fed into a duct such as a micro duct.

Although the embodiments of the present disclosure have been described, it should be noted that the technical scope the present disclosure should not be construed as being limited by the description of the present embodiments. It is understood by one skilled in the art that the present embodiments are only examples and the embodiments can be variously changed within the scope of the invention described in the claims. As such, the technical scope of the present disclosure should be determined based on the scope of the invention described in the claims and the equivalent scope thereof.

### Reference Signs List

1, 1a: optical fiber cable
2: tension member
3: optical fiber
4: optical fiber ribbon
6: water-absorbing tape
7: cable sheath
7a: outer cable sheath
7b: inner cable sheath
8: tear string
20: tension member
20a: outer tension member
20b: inner tension member
72: inner surface
D1: circumferential direction
S: accommodation space

What is claimed is:

1. An optical fiber cable comprising:
a plurality of optical fibers;
a cable sheath covering the plurality of optical fibers; and
a plurality of tension members embedded in the cable sheath,
wherein the plurality of tension members are arranged without gaps along a circumferential direction of the optical fiber cable to surround the plurality of optical fibers.

2. The optical fiber cable according to claim 1, wherein the plurality of tension members are made of fiber-reinforced plastic.

3. The optical fiber cable according to claim 1,
wherein the plurality of tension members are stranded along a longitudinal direction of the optical fiber cable.

4. The optical fiber cable according to claim 1,
wherein the plurality of tension members comprise:
a plurality of inner tension members arranged along the circumferential direction to surround the plurality of optical fibers; and
a plurality of outer tension members arranged along the circumferential direction to surround the plurality of inner tension members.

5. The optical fiber cable according to claim 4,
wherein the plurality of inner tension members are stranded in a first rotation direction along a longitudinal direction of the optical fiber cable, and
wherein the plurality of outer tension members are stranded in a second rotation direction opposite to the first rotation direction along the longitudinal direction.

6. The optical fiber cable according to claim 1,
wherein the cable sheath comprises:
an inner cable sheath; and
an outer cable sheath covering the inner cable sheath,
wherein the plurality of tension members are arranged between the inner cable sheath and the outer cable sheath, and
wherein the outer cable sheath is made of flame-retardant polyethylene to which a release agent has been added.

7. The optical fiber cable according to claim 6,
wherein the inner cable sheath is made of flame-retardant polyethylene to which no release agent is added.

8. The optical fiber cable according to claim 1,
wherein a bending stiffness in a radial direction of the optical fiber cable over an entire circumference of the optical fiber cable is within a range of 1.0 N·m² to 9.0 N·m².

9. The optical fiber cable according to claim 1, wherein a difference between maximum and minimum values of a bending stiffness in a radial direction of the optical fiber cable over an entire circumference of the optical fiber cable is within a range of 0.5 N·m² to 1.0 N·m².
